(19) United States
(12) Patent Application Publication
(10) Pub. No.: US 2009/0224482 A1
(43) Pub. Date: Sep. 10, 2009

(54) Custom Flow Cell Gasket and Assemblies and Methods Thereof

(75) Inventor: James C. Nurse, Pleasanton, CA (US)

Correspondence Address: LIFE TECHNOLOGIES CORPORATION;C/O INTELLEVATE, P.O. BOX 52050, MINNEAPOLIS, MN, 55402, US

(73) Assignee: Life Technologies Corporation, Carlsbad, CA (US)

(21) Appl. No.: 12/397,697

(22) Filed: Mar. 4, 2009

Related U.S. Application Data
(60) Provisional application No. 61/033,602, filed on Mar. 4, 2008.

(51) Int. Cl. F16J 15/02

(52) U.S. Cl. 277/312; 277/637

(57) ABSTRACT

Various embodiments of a custom gasket for use in a flow cell assembly are disclosed. In various embodiments of a custom gasket for a flow cell assembly, the gasket may have a compressible wedge providing a fluid-tight seal at a gasket-fluid interface. In various embodiments of a custom gasket for a flow cell assembly, the gasket may provide a zero dead volume flow path in a flow cell, enabling features such as decreased fluid carry-over and decreased flow cell wash time in comparison to conventional flow cell gaskets.

### FIELD

The present application relates to embodiments of a flow cell assembly comprising a plate, a gasket, and a cover, wherein the gasket provides a zero dead volume seal for the flow cell assembly.

### BACKGROUND

A flow cell assembly integrated into a fluid handling system is generally a multicomponent system well suited to high-throughput analysis. Different fluid handling systems into which a flow cell assembly may be integrated may have a plurality of components including, for example, a flow cell, fluid reservoirs for sample storage, as well as various solutions and reagents required for any particular assay protocol, collections reservoirs for sample or waste collection, fluid delivery assemblies, such as pumps, valves, fittings, and controllers thereof, as well as lines or tubing to interconnect the various components in the fluid handling system.

In many types of chemical and biological analysis, high precision may be a necessary analytical attribute in order for the analysis to be meaningful to the end user. As such, multicomponent systems may have a variety of components that can impact assay precision as sources of system noise. System noise, also referred to as process noise, may arise from one or a combination of system components or steps, for example but not limited by, apparatus, reagent, protocol, and the like. If the source or sources of process noise can be correctly identified, such process noise may be reduced, and possibly eliminated, increasing assay precision thereby. Carry-over of sample, solution, reagent, or the like, may be one source of process noise. Carry-over, as the word implies, may be generally used to mean the residual amount of sample, solution, reagent, or the like that is carried over throughout a multicomponent system from one analysis to the next, and as such, may have an impact on assay precision. In such multicomponent systems, sources of carry-over may be challenging to identify and effectively reduce or eliminate.

Dye tracing analysis was used to identify components contributing to process noise in a multicomponent system including a flow cell integrated into a fluid handling system. As a result of the analysis, a need was identified for a custom flow cell gasket.

### SUMMARY

In various embodiments the present teachings provide a gasket for sealing a flow cell assembly comprising: a body comprising a foot for seating the gasket in the flow cell, and a spacer defining the flow cell volume; a spacer lip orthogonal to the gasket body and oriented into the flow cell, wherein the spacer lip is adapted to provide a reduced dead volume flow path in the flow cell; and a compressible wedge portion of the spacer lip, wherein the compressible wedge provides a seal for the flow cell. In other embodiments the present teachings provide a flow cell assembly comprising: a plate, wherein the plate is adapted to seat a gasket; the gasket comprising: a body comprising a foot for seating the gasket in the flow cell, and a spacer defining the flow cell volume; a spacer lip orthogonal to the gasket body and oriented into the flow cell, wherein the spacer lip is adapted to provide a reduced dead volume flow path in the flow cell; a compressible wedge portion of the spacer lip, wherein the compressible wedge portion provides a seal for the flow cell; and a cover, wherein the gasket is disposed between the plate and the cover so that the gasket provides a zero dead volume seal in the flow cell assembly.

In still other embodiments, the present teachings provide a method for sealing a flow cell comprising: providing a flow cell assembly comprising a plate, a gasket, and a cover, wherein the plate is adapted to seat a gasket; mounting the gasket in the plate, wherein the gasket comprises: a body comprising a foot for seating the gasket in the flow cell, and a spacer defining the flow cell volume; a spacer lip orthogonal to the gasket body and oriented into the flow cell, wherein the spacer lip is adapted to provide a reduced dead volume flow path in the flow cell; a compressible wedge portion of the spacer lip, wherein the compressible wedge portion provides a seal for the flow cell; and sealing the plate, gasket, and cover wherein the gasket provides a zero dead volume compression seal for the flow cell assembly.

### BRIEF DESCRIPTION OF THE DRAWINGS

FIG. 1A is a plan view of a flow cell plate according to various embodiments FIG. 1B is a partial long section through the plate. FIGS. 1C and 1D depict a flow cell assembly according to various embodiments, having a conventional gasket seated in a gasket groove.

FIGS. 2A-2C depict various aspects of conventional gaskets that may lead to regions of dead volume forming in embodiments of a flow cell assembly.

FIG. 3A is a plan view of a flow cell plate and a custom gasket according to various embodiments. FIG. 3B depicts a section of the gasket according to various embodiments in a region close to a port in the flow cell plate, and FIG. 3C depicts a section of the gasket according to various embodiments in a region along the flow channel.

FIGS. 4A-4F depict the process of sealing a flow cell assembly using a gasket according to various embodiments custom gaskets providing for a zero dead volume flow cell seal.

FIG. 5 is a schematic of an exemplary fluid handling system according to various embodiments for use with various embodiments of a zero dead volume flow cell assembly.

FIGS. 6A-6B display a bar chart of fluorescent count as a function of wash step, providing side-by-side comparison of the flow cell wash (front graph) and the pump assembly wash (back graph) for a conventional gasket in a flow cell assembly (FIG. 6A) versus a custom gasket according to various embodiments of a zero dead volume flow cell assembly (FIG. 6B).

### DETAILED DESCRIPTION

Various embodiments of a custom gasket for use in a flow cell assembly are disclosed herein, as well as assemblies and methods utilizing embodiments of such gaskets. According to various embodiments of a custom gasket, the gasket may have a compressible wedge providing a fluid-tight seal at a gasket-fluid interface. According to various embodiments of a custom gasket for a flow cell assembly, the gasket may also provide a zero dead volume flow path in a flow cell, enabling features such as decreased fluid carry-over and decreased flow cell wash time in comparison to conventional flow cell gaskets. According to various embodiments of a custom gasket for use in a flow cell assembly, the gasket may provide for ease of seating in a flow cell plate, ensuring that features such a fluid-tight seal and zero dead volume flow path are consistently afforded to the end user.

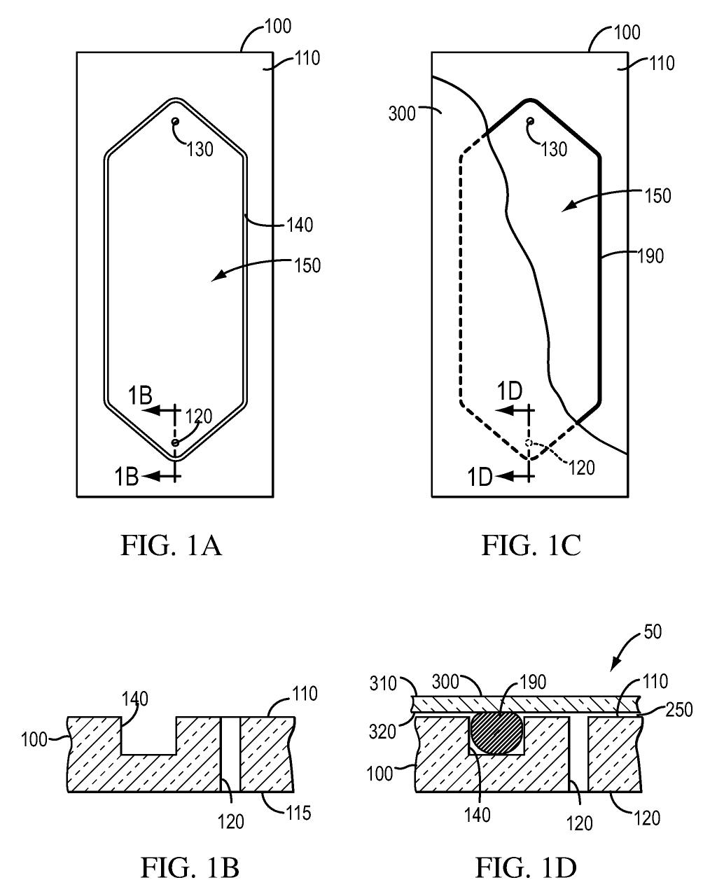

As depicted in FIGS. 1A and 1B, according to various embodiments of a flow cell assembly, such an assembly may have a plate 100, having a first surface 110 and a second surface 115 (FIG. 1B). In various embodiments of a flow cell assembly 50, plate 100 may have a first port 120 and a second port 130 formed in the plate, as well as a gasket groove 140. The region of plate 100 defined inside of the gasket groove 140 is flow cell channel region 150. As shown in FIG. 1B, according to various embodiments of plate 100 for flow cell assembly 50, the spacing between a port; such as port 120, and a gasket groove, such as gasket groove 140, must be sufficient enough to provide mechanical stability for plate 100, as will be discussed in more detail subsequently. In FIG. 1C, flow cell assembly 50, having plate 100, gasket 190, and cover 300, is shown. Cover 300 has a first surface 310 and a second surface 320. As depicted in f FIG. 1D, conventional flow cell gasket 190 may have a substantially round cross-section, such as, for example, an o-ring gasket. According to various embodiments of flow cell gaskets, the material used for the gasket may be a compressible material, such as a polymeric material. When a conventional gasket is compressed, it may form a seal between plate 100 and cover 300, where second surface 320 of cover 300 is in fluid contact with flow channel 250. The radius of a conventional gasket may be selected so as to provide a gap between the plate 100 and the cover 300. As such, a flow channel 250 may be formed between the plate 100 and the cover 300; where the flow channel 250 may have a flow cell channel depth determined by the gap provided using the gasket 190. The flow channel depth in turn determines the flow channel volume.

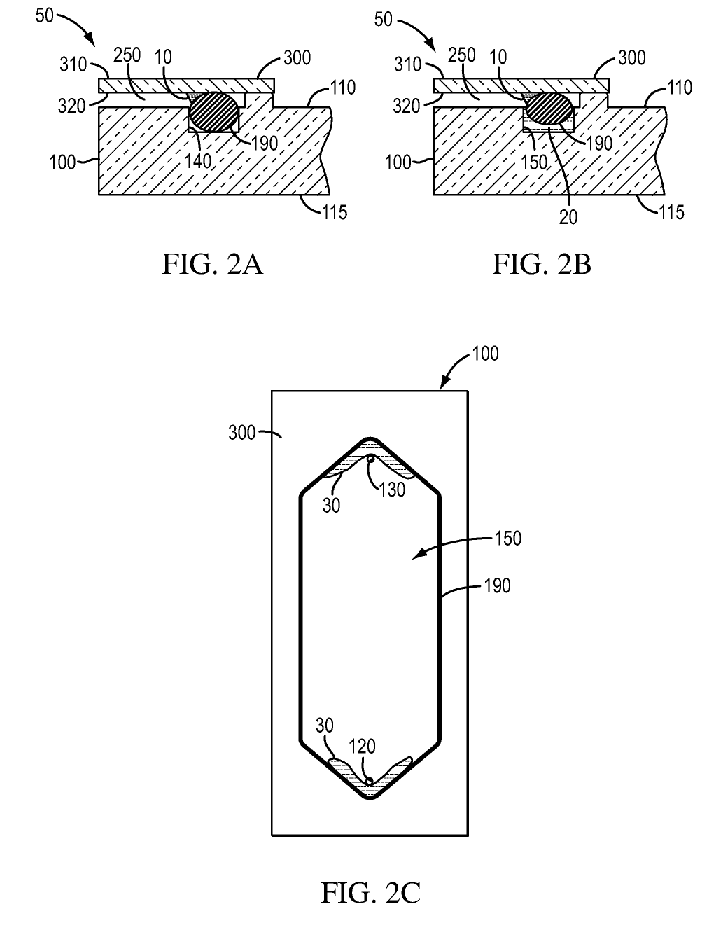

As further illustrated in FIGS. 2A-2C, conventional flow cell gaskets have drawbacks that were characterized by extensive analysis performed by the inventor using dye tracers. According to various embodiments of conventional flow cell gaskets, as discovered from the analysis performed by the inventor, dead volume may arise in a region bounded by the curvilinear portion of a conventional gasket 190 and second surface 320 of flow cell cover 300. This dead volume is illustrated in FIG. 2A as dead volume region 10. Additionally, seating a conventional flow cell gasket, such as flow cell gasket 190, may result in certain portions of the gasket being seated incompletely in a gasket groove, as discovered from the analysis performed by the inventor. Such as gasket groove 140, resulting in dead volume region 20 forming in the gasket groove, as depicted in FIG. 2B. As previously mentioned, according to various embodiments of a flow cell plate, there needs to be a sufficient space between a port, such as ports 120 and 130, and a gasket groove, such as gasket groove 140, to provide sufficient material strength to prevent cracking, warping, breakthrough and the like between a port and a gasket groove. As discovered from the analysis performed by the inventor, and depicted in the plan view of FIG. 2C, in providing sufficient space between a port and a gasket grove, according to various embodiments of flow cell plate 100, dead volume regions 30 between a port and a gasket may be formed.

Dead volume regions as illustrated in FIGS. 2A-2C may introduce process noise in a flow cell assembly integrated into a fluid handling system. Using dye tracing, the inventor determined that such dead volume regions may introduce fluid carry-over for several flow cell volumes, as a result of the slow bleed of fluids trapped in dead volumes. Such fluid carry-over from fill to fill may introduce, for example, poor precision in chemical and biological analyses utilizing flow cells. As a result of the analysis performed by the inventor, it was additionally determined that that in order to eliminate the fluid in trapped dead volumes from a flow cell assembly as illustrated in FIGS. 2A-2C, extensive washing calling for numerous flow cell volumes of wash solution may have to be performed. Given a variety chemical and biological analyses performed using various embodiments of a flow cell assembly as illustrated in FIGS. 2A-2C, such extensive flow cell washes were determined to have a surprising increase on analysis throughput time, as will be discussed in more detail subsequently.

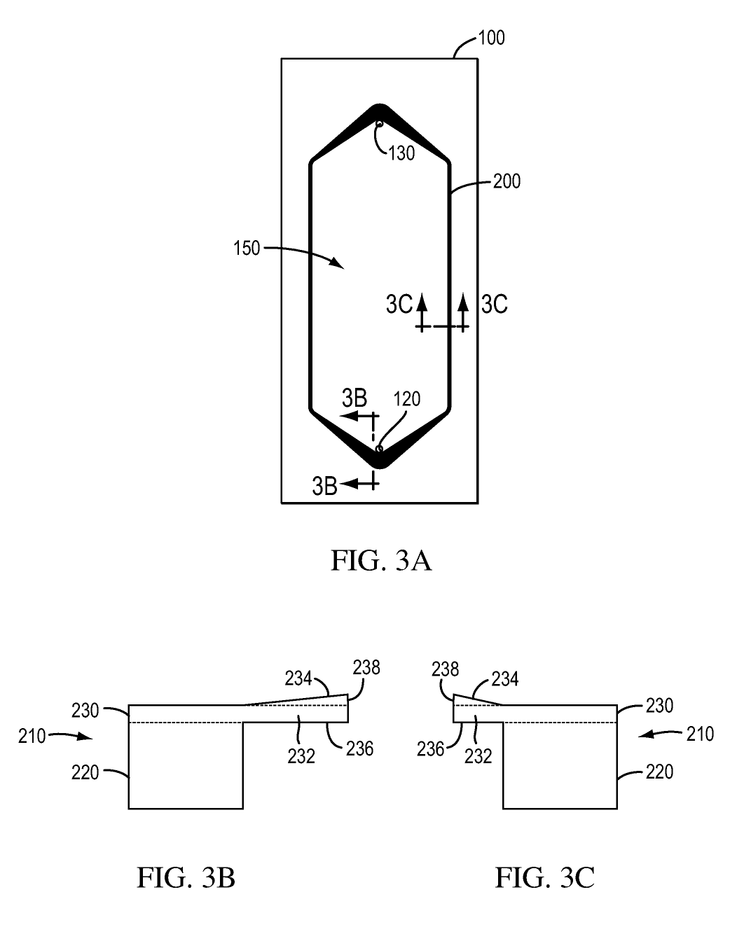

In FIG. 3A, a plan view of a custom flow cell gasket 200 according to various embodiments is depicted. Cross sections of custom flow cell gasket 200 shown in the plan view of FIG. 3A are near the port 120 and along the flow cell channel region 150, as shown in FIG. 3B and FIG. 3C, respectively. According to various embodiments as shown in the cross-sections of FIG. 3B and FIG. 3C, custom flow cell gasket 200 may have a body 210 including a foot or anchor 220, and a spacer 230. In various embodiments of a custom flow cell gasket 200, the foot or anchor 220 is used to seat gasket 200, eliminating a potential dead volume space in gasket groove 140 thereby. In various embodiments of a custom flow cell gasket, the spacer 230 has a lip 232, which is substantially orthogonal to the gasket body, and oriented into the flow cell channel. According to various embodiments of a custom flow cell gasket 200, the spacer 230, having spacer lip 232 may define a flow cell channel depth, defining the flow cell volume thereby. In various embodiments of a custom flow cell gasket, spacer lip 232 of spacer 230 may have a first surface 234 and a second surface 236. According to various embodiments of a custom flow cell gasket, a compressible wedge 238 may be formed as a part of the spacer lip first surface 234. As depicted in FIGS. 3A-3C, various embodiments of a custom flow cell gasket 200 may have a lip with variable length, so that in the region close to the ports, the spacer lip is adapted to eliminate dead volume 30, as previously described and shown in FIG. 2C.

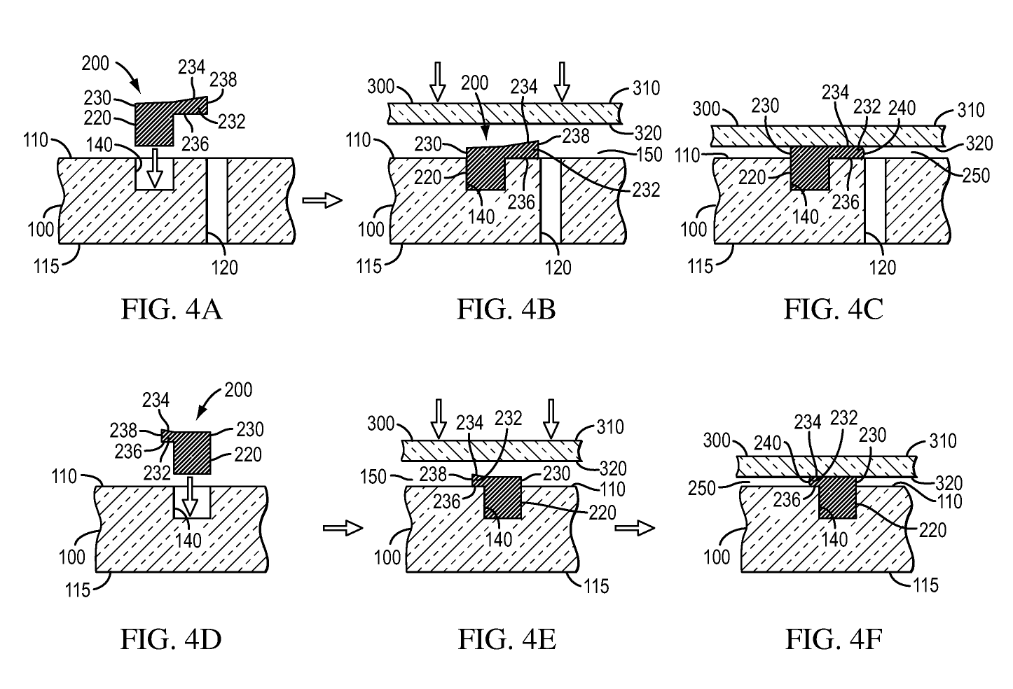

Materials appropriate for various embodiments of custom gasket 200 may have properties that include being stable and flexible from between about −50° C. to about 200° C., protecting against mechanical thermal stress thereby, and having excellent dielectric properties. Further, for range of chemical and biological analyses, the material may have essentially no intrinsic fluorescence. Additionally, for a range of biological analyses, the custom gasket material may have essentially no inhibitors, such as, but not limited by metals, plasticizers, stabilizers, and the like, that may be leached into the analysis stream. Materials appropriate for embodiments of custom gasket 200 may range in surface energy from hydrophobic to hydrophilic, depending on the application, and may be suitable for altering such a property as desired. For example, the surface energy of a material may be suitably altered through treatment, including for example, plasma ashing, material thin film deposition, chemical modification of the surface, and the like. An exemplary class of materials suitable for use in the fabrication of embodiments of custom gasket 200 includes silicone elastomers. As depicted In FIGS. 4A-4F, various flow cell assemblies may be formed using embodiments of custom flow cell gasket 200. The sequence depicted in FIGS. 4A-4C, may be taken through a partial long section near a port, such as port 120, while the sequence depicted in FIGS. 4D-4F may be taken through a partial cross section along a flow cell channel. In a first step, as depicted in FIGS. 4A and 4D, a custom gasket 200 may be oriented for seating in gasket groove 140 of plate 100. As depicted in FIGS. 4B and 4E, when the foot or anchor 220 of custom gasket 200 is seated in the gasket groove 140, gasket groove dead volume may be eliminated. Additionally, spacer 230 may be selected according to a desired flow channel depth, and therefore a desired flow channel volume. Further, the spacer lip 232, which is oriented into the flow channel region 150, may have spacer lip compressible wedge 238, oriented towards cover 300. As depicted in FIGS. 4C and 4F, in a step in which cover 300 is secured over plate 100, flow channel 250 is formed. In various embodiments of a flow cell assembly, compressible wedge 238 may form a seal 240 at the gasket-flow channel interface. According to various embodiments of seal 240 using compressible wedge 238, such a seal may be fluid-tight.

Materials that may be useful for plate 100 include a number of substantially rigid material, for example, but not limited by, such as polymers, metals, inorganic oxide materials, such as glasses and sapphire-based materials, and ceramics. The substantially rigid material for plate 100 may be treated to provide a surface coating that can enhance flow cell function. Numerous surface coatings are possible, such as a polymer thin film, where the polymer may be selected from a range of physical and surface chemistry properties, such as, for example polyhalohydrocarbon, polystyrene, polyamide, polyimide and the like. Alternatively, a surface coating could be an inorganic coating, such as a silicon nitride, silicon carbide, silicon oxide, or diamond. Materials that may be useful for cover 300 include numerous materials having properties including being substantially rigid, optically flat, and optically transmissive materials with low fluorescent background. Classes of materials having such properties may include inorganic oxide materials, such as glasses and sapphire-based materials, as well as polymers. Polymer materials having the aforementioned properties include, for example, polycarbonates, polystyrenes, and polyolefins. Olefin polymers, such as polypropylene, polyethylene, and the like are some exemplary materials having such characteristics. For example, various types of cyclic olefin polymers are known to have good optical properties, while biaxially oriented polypropylenes are known to have properties such as superior strength at low gauges, flatness, and optical clarity.

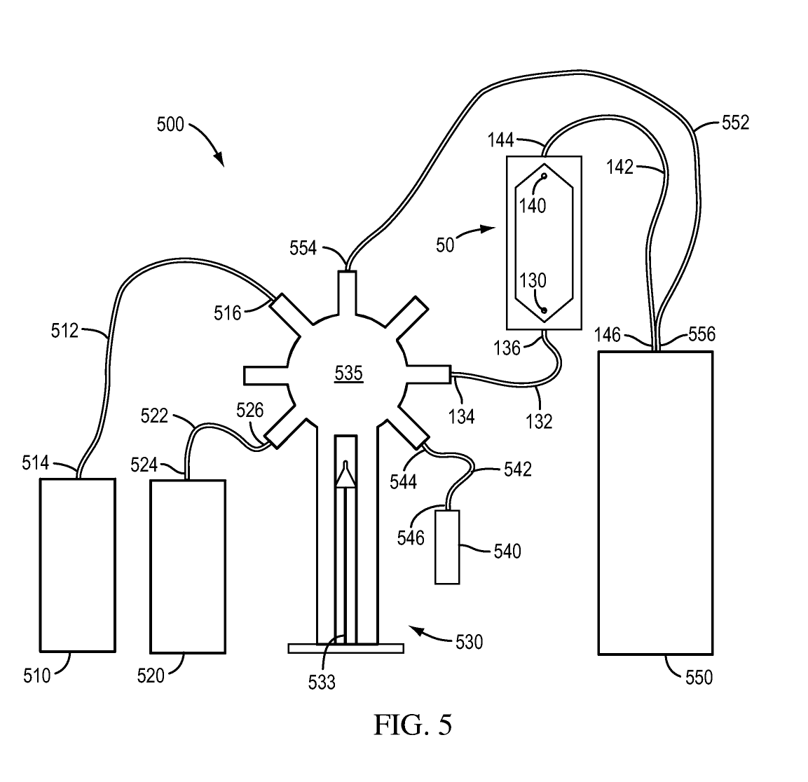

FIG. 5 depicts a fluid handling system for a flow cell assembly 500, according to various embodiments of flow cell assemblies utilizing a custom gasket. In various embodiments of fluid handling systems, fluids may be controllably delivered to a flow cell, and may be controllably removed from the flow cell.

Various embodiments of a fluid handling system for a flow cell may have a plurality of fluid reservoirs. For example, as indicated in FIG. 5, a fluid handling system may have at least a first a fluid reservoir 510 and a second fluid reservoir 520. According to various embodiments of a fluid handling system for a flow cell, at least one of the plurality of fluid reservoirs may be used for a reagent for a chemical or biological analysis. In various embodiments of a fluid handling system for a flow cell, at least one of the plurality of fluid reservoirs may be used for a solution, such as a buffer. According to various embodiments of a fluid handling system for a flow cell, at least one of the reagent reservoirs may contain a gas for example nitrogen. Various embodiments of a fluid handling system for a flow cell may have at least one pump. For example, as indicated in FIG. 5, various embodiments of a fluid handling system may have at least one pump 530. According to various embodiments, pump 530 may have at least one mechanism for pumping fluids 533, such as a piston, syringe, and the like, as well as at least one multi-position valve 535, allowing a plurality of controllable flow paths. Additionally, according to various embodiments of a fluid handling system for a flow cell, a pump may be designed so that a plurality of reagents and solutions from different fluid reservoirs may be mixed before delivery to the flow cell. Various embodiments of a fluid handling system for a flow cell may have a plurality of collection reservoirs. For example, as indicated in FIG. 5, a fluid handling system may have at least a first a collection reservoir 540 and a second collection reservoir 550. According to various embodiments of a fluid handling system for a flow cell, at least one of the plurality of collection reservoirs may be used for collecting a sample from the flow cell. In various embodiments of a fluid handling system for a flow cell, at least one of the plurality of collection reservoirs may be used as a waste reservoir.

As indicated in FIG. 5, the fluid handling system for a flow cell assembly 50 may have a plurality of lines for controllable fluid communication between various components of the fluid handling system. For example, first fluid reservoir 510 may have first fluid reservoir line 512, having a first end 514 in fluid communication with the first fluid reservoir 510, and a second end 516 in fluid communication with pump 530 through multi-position valve 535. Similarly, second fluid reservoir 520 may have second fluid reservoir line 522, having a first end 524 in fluid communication with the second fluid reservoir 520, and a second end 526 in fluid communication with pump 530 through multi-position valve 535. In an analogous fashion, first collection reservoir 540 may have first collection reservoir line 542, having a first end 544 in fluid communication with pump 530 through multi-position valve 535 and a second end 546 in fluid communication with the first collection reservoir 540. Likewise, second collection reservoir 550 may have second fluid reservoir line 552 having a first end 554 in fluid communication with pump 530 through multi-position valve 535 and a second end 526 in fluid communication with the second collection reservoir 550. In order for fluids to be pumped into the flow cell, flow cell assembly 50 may be fitted with a first flow cell port line 122, having a first end 124 in fluid communication with pump 530 through multi-position valve 535, and a second end 126 in fluid communication with first port 120. In order for fluids to be pumped out of the flow cell, flow cell assembly 50 may be fitted with a second flow cell port line 132, having a first end 134 in fluid communication with second port 130, and a second end 136 in fluid communication with the second collection reservoir 550.

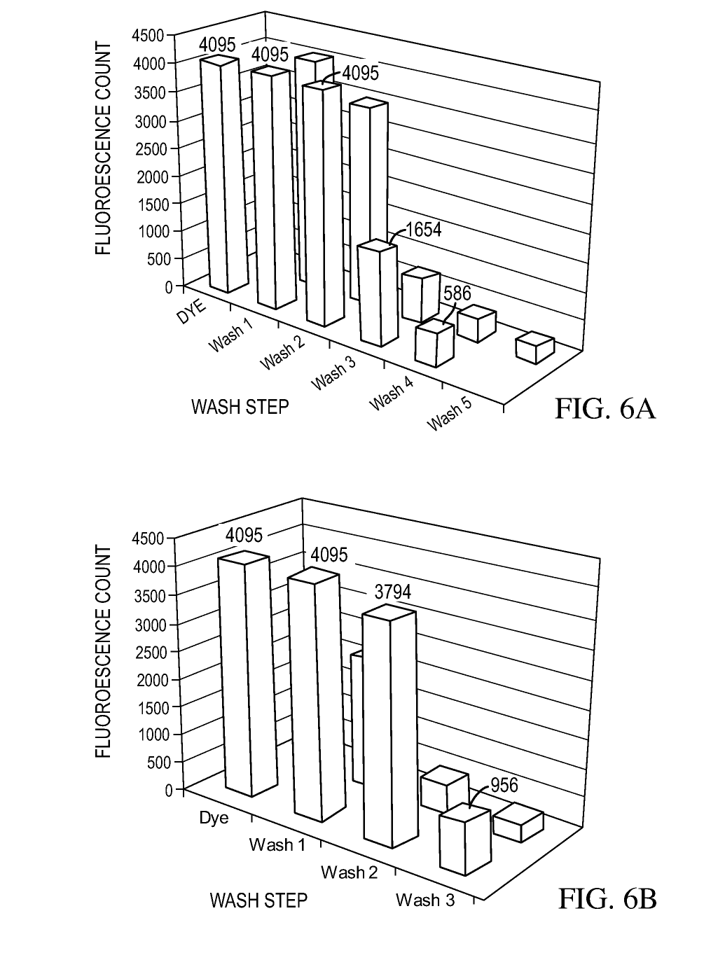

FIGS. 6A and 6B are bar charts that present fluorescent count as a function of wash step, providing side-by-side comparison of the flow cell wash 610 and the pump assembly wash 620. FIG. 6A presents data for a conventional gasket in a flow cell assembly, while FIG. 6B presents data for a custom gasket according to various embodiments of a zero dead volume flow cell assembly. The comparison of the bar charts presented in FIGS. 6A and 6B serve to highlight features of various embodiments of a custom gasket, and additionally illustrate how a fluid handling system may be used with flow cell assembly 50 of FIG. 5.

The protocol for the data presented was as follows: A flow cell assembly 50 was arranged in a fluid handling system as depicted in FIG. 5. For the data collected in FIG. 6A, a flow cell assembly 50 having a conventional o-ring gasket, such as depicted in FIG. 1B was used. For the data collected in FIG. 6B, a flow cell assembly 50 having a custom gasket according to various embodiments of a gasket, such as depicted in FIG. 3A was used. One reservoir, such as first fluid reservoir 510, contained a solution of a dye mixture composed of 6-carboxy-fluorescein (FAM), 1,2-dihexadecanoyl-sn-glycero-3-phosphoethanolamine, triethylammonium salt (Texas Red), and the cyanine dyes Cy3 and Cy5, all in 50 micromolar concentration. Another reservoir, such as fluid reservoir 520, contained a wash solution (Applied Biosystems instrument buffer; part number 4387919).

In a first step, the flow cell was filled with the dye solution, and then withdrawn into a collection reservoir, such as collection reservoir 540. This solution representing undiluted dye solution was measured using a fluorescent detector, using an excitation wavelength of 488 nm and an emission wavelength of 518 nm, for measuring the FAM component of the dye mixture. The first bar nearest the origin charted on both graphs, and indicated as bar chart 610, represents the fluorescent emission signal measured for the undiluted dye solution. In a next step, in order to clear the pump and associated fluid lines, such as fluid lines 132 and 542, of residual dye solution, the wash solution, contained in a fluid reservoir, such as second fluid reservoir 520, was flushed through the pump and lines and into a collection reservoir, such as collection reservoir 540. This solution for the pump wash was read using a fluorescent detector, as described for the step of reading the dye solution. The first bar nearest the origin charted on both graphs, and indicated as bar chart 620, represents the fluorescent emission signal measured for the first pump wash solution. In a next step, the glycerol solution was flushed into the flow cell, and then withdrawn into a collection reservoir, such as collection reservoir 540, and the fluorescent emission of the flow cell wash solution was read. The bar charted on both graphs as second bar from the left for plot 610 represents the fluorescent emission signal measured for the first flow cell wash solution. In a next step, a second pump wash as previously described, which was read and plotted. The procedure of washing, collecting the wash, and reading the fluorescent signal for the flow cell wash and alternatingly the pump wash was done until the measured fluorescent signal was sufficiently low, as represented in FIGS. 6A and 6B.

As given by inspection of FIG. 6A, for a flow cell assembly using a conventional gasket, the first pump wash produces a signal intensity that is comparable to the measurement of the dye flushed from the flow cell assembly. In fact, as can be seen in FIG. 6A, the first and second cell washes show no reduction in signal intensity. Additionally, for a flow cell assembly using a conventional gasket, the second pump was only about 12% less than the first pump wash (FIG. 6A). Surprisingly, in contrast, in review of the results for a flow cell assembly with an embodiment of a custom gasket given in FIG. 6B, there is a 50% decrease in fluorescent intensity for the first pump wash versus the flow cell assembly with a conventional gasket. This indicates that there was significantly less residual dye as a result of significant reduction of the total dead volume using an embodiment of a flow cell assembly with the custom gasket versus a flow cell assembly with a conventional gasket. As a result of significantly less residual dye in the flow cell assembly using an embodiment of a custom gasket, the third wash for a flow cell assembly with an embodiment of a custom gasket was 40% less than a flow cell assembly with the conventional gasket. Surprisingly, the time savings for a flow cell assembly with an embodiment of a custom gasket versus a flow cell assembly with the conventional gasket was between about 0.5 minute to about 1 minute using the above described protocol. As flow cells are generally used in high-throughput sequential analysis systems, decreasing the per-analysis assay time by decreasing the per-analysis wash time may have a significant impact on sample throughput.

Initially, the identification of sources of sequestered dye in a fluid handling system utilizing a flow cell was motivated by increasing assay precision by decreasing process noise due to fluctuating dye levels resulting from system carry-over. Additionally, it was discovered that the flow cell assembly with embodiments of a custom gasket provides for significantly decreased wash times per analysis. Embodiments of a custom gasket for a flow cell assembly described herein have attributes that may include providing a zero dead volume flow path for a flow cell assembly, providing a fluid-tight seal at a gasket-fluid interface, providing ease of installation resulting in reliable use for an end user, and providing ease in adjusting the flow cell volume by varying the thickness of the gasket lip

While the principles of this invention have been described in connection with specific embodiments, it should be understood clearly that these descriptions are made only by way of example and are not intended to limit the scope of the invention. What has been disclosed herein has been provided for the purposes of illustration and description. It is not intended to be exhaustive or to limit what is disclosed to the precise forms described. Many modifications and variations will be apparent to the practitioner skilled in the art. What is disclosed was chosen and described in order to best explain the principles and practical application of the disclosed embodiments of the art described, thereby enabling others skilled in the art to understand the various embodiments and various modifications that are suited to the particular use contemplated. It is intended that the scope of what is disclosed be defined by the following claims and their equivalence.

What is claimed:

1. A gasket for sealing a flow cell assembly comprising:
a body comprising a foot for seating the gasket in the flow cell, and a spacer defining the flow cell volume;
a spacer lip orthogonal to the gasket body and oriented into the flow cell, wherein the spacer lip is adapted to provide a reduced dead volume flow path in the flow cell; and
a compressible wedge portion of the spacer lip, wherein the compressible wedge provides a seal for the flow cell.

2. The gasket of claim 1, further comprising a plate adapted to seat the gasket.

3. The gasket of claim 2, wherein the plate contains a gasket groove adapted to seat the gasket on the plate in a predetermined location and orientation.

4. The gasket of claim 1, wherein the gasket comprises a material with substantially no intrinsic fluorescence.

5. The gasket of claim 1, wherein the gasket comprises a non-inhibitory material so as to permit reactions for biological analysis to be conducted within the flow cell.

6. The gasket of claim 1, wherein the reduced dead volume flow path reduces fluidic carryover during flow cell washes.

7. The gasket of claim 1, wherein the reduced dead volume flow path comprises a substantially zero dead volume flow path.

8. The gasket of claim 1, wherein the gasket is pre-treated to alter its surface energy properties.

9. A flow cell assembly comprising:
a plate, wherein the plate is adapted to seat a gasket;
the gasket comprising:
a body comprising a foot for seating the gasket in the flow cell, and a spacer defining the flow cell volume;
a spacer lip orthogonal to the gasket body and oriented into the flow cell, wherein the spacer lip is adapted to provide a reduced dead volume flow path in the flow cell;
a compressible wedge portion of the spacer lip, wherein the compressible wedge portion provides a seal for the flow cell; and
a cover, wherein the gasket is disposed between the plate and the cover so that the gasket provides a reduced dead volume seal in the flow cell assembly.

10. The gasket of claim 9, wherein the plate contains a gasket groove adapted to seat the gasket on the plate in a predetermined location and orientation.

11. The gasket of claim 9, wherein the gasket comprises a material with substantially no intrinsic fluorescence.

12. The gasket of claim 9, wherein the gasket comprises a non-inhibitory material so as to permit reactions for biological analysis to be conducted within the flow cell.

13. The gasket of claim 9, wherein the gasket is pre-treated to alter its surface energy properties.

14. The gasket of claim 9, wherein the reduced dead volume flow path reduces fluidic carryover during flow cell washes.

15. The gasket of claim 9, wherein the reduced dead volume flow path comprises a substantially zero dead volume flow path.

16. A method for sealing a flow cell comprising:
providing a flow cell assembly comprising a plate, a gasket, and a cover, wherein the plate is adapted to seat a gasket;
mounting the gasket in the plate, wherein the gasket comprises:
a body comprising a foot for seating the gasket in the flow cell, and a spacer defining the flow cell volume;
a spacer lip orthogonal to the gasket body and oriented into the flow cell, wherein the spacer lip is adapted to provide a reduced dead volume flow path in the flow cell;
a compressible wedge portion of the spacer lip, wherein the compressible wedge portion provides a seal for the flow cell; and
sealing the plate, gasket, and cover wherein the gasket provides a zero dead volume compression seal for the flow cell assembly.

17. The method of claim 16, wherein the plate contains a gasket groove adapted to seat the gasket on the plate in a predetermined location and orientation.

18. The method of claim 16, wherein the gasket comprises a material with substantially no intrinsic fluorescence.

19. The method of claim 16, wherein the gasket comprises a non-inhibitory material so as to permit reactions for biological analysis to be conducted within the flow cell.

20. The method of claim 16, wherein the gasket is pre-treated to alter its surface energy properties.

21. The method of claim 16, wherein the reduced dead volume flow path reduces fluidic carryover during flow cell washes.

22. The method of claim 16, wherein the reduced dead volume flow path comprises a substantially zero dead volume flow path.
